(19) United States
(12) Patent Application Publication
(10) Pub. No.: US 2007/0122643 A1
(43) Pub. Date: May 31, 2007

(54) Covered and edged lumber product

(76) Inventor: Mark David Summitt, (US)

Correspondence Address: Charles Y. Lackey, P. O. Box 5871, Winston-Salem, NC, 27106, US

(21) Appl. No.: 11/288,487

(22) Filed: Nov. 30, 2005

(51) Int. Cl. B32B 21/14

(52) U.S. Cl. 428/537.1; 428/68; 428/76

(57) ABSTRACT

A veneer covered and edged wood product having a core made of cheap, common grade wood or other materials which has a generally rectangular cross section. The core can be formed to incorporate desired features such as stability and straightness and can be treated to obtain flame resistant and moisture resistant characteristics so that the end product appears to be a solid piece of high quality lumber. A process for forming the product includes assembling a large sheet of core material between two large sheets of quality veneer, ripping the assembled sheets into strips of a preselected width and then bonding a thin sliced veneer strip to each side edge.

### BACKGROUND OF THE INVENTION

### 1. Field of the Invention

The present invention is a covered face and edge product which gives the appearance of high grade solid sawn lumber but is actually encased in a coating of high grade finished veneer. The core is selected from wood or non-wood material chosen to incorporate high dimensional stability and freedom from warpage.

The availability of high grade lumber is becoming more limited, and tropical woods are now being imported to fill this declining commodity. There is also a growing practice to end and/or edge join smaller pieces of quality wood into larger standard size units.

The clear wide lumber cut from tropical trees is expensive and, often lacks desirable physical properties and tends to have a bland grain pattern. The edge and end glued products lack continuity of grain pattern so that it is essential for them to be finished with opaque or grain-covering paints.

A third attempt to find substitutes for high grade lumber is to laminate a number of wood pieces to simulate a solid piece of sawn lumber. However, very often the laminated pieces are apparent along their bonded edges or in the end grain of the finished product. While this does not detract from the function of the end product, the appearance has met with considerable consumer resistance.

As the availability of high grade solid wood decreases, so does the quality. Much of the material available now is from second or later growth trees which many times have much more widely spaced annual rings than old growth timber. Second or later growth lumber is more normally available in flat grain or generally tangentially sawed lumber, and its appearance is not as highly regarded. It has, however, an even greater problem in that it has a much greater tendency to warp than lumber from old growth logs. Warpage occurs in either twist, bow or crook or some combination thereof.

Thus, there continues to be a need for substitute products for first grade solid wooden materials, and it to that continuing and growing need that the present invention is directed.

### SUMMARY AND OBJECTIVES OF THE INVENTION

The present invention is, in part, a covered face and edge lumber-included product having a core member which has a generally rectangular cross section. The core member can be made of cheaper, lower grade and more common wood or other products and engineered to provide a desired level of hardness, stability, straightness, strength, screw-holding power and other characteristics. Moisture and flame resistance and weight are obtainable to a desired level since different core materials and constructions can be used.

Once the materials of the core member and covering veneer have been selected, they are assembled in large, substantially similar sized sheets, the large sheet of the core material having a front face and a back face, each face covered with a large sheet of the chosen veneer and all bonded together. The size of the sheets are pre-selected to assure that the formed end product will be in standard lengths.

The bonded core member and veneer sheets are then ripped into strips of a pre-selected width so that smooth and precise smaller side edges are formed on all formed strips. A thin sliced veneer strip having a width of precisely the thickness of the core member and the top and bottom sheets of veneer is then bonded to each side edge so that each formed strip is substantially covered (except for the strip ends) with veneer to simulate a solid wood lumber product.

The invention has superior appearance and dimensional stability, potentially lower cost and higher yield in use than product manufactured from solid lumber. The product face, back and both edges are covered in wood veneer. Wood veneer is generally clearer, more uniform and more aesthetically pleasing than lumber of the same species due to the manufacturing techniques and log selection criteria employed in veneer production. Product characteristics such as weight, strength, hardness, rigidity, moisture resistance, flame resistance, dimensional stability, and costs may be tailored to the application since different core materials and constructions can be used. These characteristics of the core are independent of the species of the veneer used referred to hereinafter as the “Perceived Species”.

For example, conventional wood products made of solid white oak lumber are very heavy. The same product replicated using the process and materials comprising the present invention can be made light in weight by using special low-density core material such as lumbercore and yet be indistinguishable from the solid lumber product. Using cheaper, lower grade and more common wood products obviously results in a lower material cost.

The visible surfaces of the Perceived Species are essentially wood defect-free. Yield of core-covering veneer compared to the yield of lumber product is much higher since the lumber product generally contains more wood defects such as knots, splits and the like.

The end product of the present invention is of a pre-selected length whereas the lumber product is generally of random length. Customers usually cut parts of certain lengths from these fixed length pieces, so the ability to use fixed lengths gives a higher and more predictable yield than similar products made from solid lumber.

From the foregoing summary, it can be seen that it is a primary object of the present invention to provide a covered and edged lumber product that has a core member substantially covered with high quality wood veneer so that the formed wood product simulates a solid wood lumber product.

Another object of the present invention is to provide a wood lumber product of excellent appearance and relative freedom from warpage in pre-selected lengths.

A further object of the present invention is to provide a wood lumber product which is efficiently constructed from readily available materials.

Yet still another object of the present invention is to provide a process for making the wood lumber product of the present invention.

Thus there has been outlined the more important features of the invention in order that the detailed description that follows may be better understood and in order that the present contribution to the art may be better appreciated. There are, of course, additional features of the invention that will be described hereinafter and which will form the subject matter of the claims appended hereto. In that respect, before explaining at least one embodiment of the invention in detail, it is to be understood that the invention is not limited in its arrangement of the components set forth in the following description and illustrated in the drawings. The invention is capable of other embodiments and of being practiced and carried out in various ways.

It is also to be understood that the phraseology and terminology employed herein are for the purpose of description and should not be regarded as limiting in any respect. Those skilled in the art will appreciate that the concept upon which this disclosure is based may readily be utilized as a basis for designing other structures, methods and systems for carrying out the several purposes of this development. It is important that the claims be regarded as including such equivalent methods and products resulting therefrom that do not depart from the spirit and scope of the present invention. The application is neither intended to define the invention of the application, which is measured by its claims, nor to limit its scope in any way.

Thus, the objectives of the invention set forth above, along with the various features of novelty, which characterize the invention, are noted with particularity in the claims annexed to and forming a part of this disclosure. For a better understanding of the invention, its operating advantages and the specific results obtained by its use, reference should be made to the following detailed specification taken in conjunction with the accompanying drawings wherein like characters of reference designate like parts throughout the several views.

The drawings are included to provide a further understanding of the invention and are incorporated in and constitute a part of this specification. They illustrate embodiments of the invention and, together with their description, serve to explain the principles of the invention.

### BRIEF DESCRIPTION OF THE DRAWINGS

FIG. 1 is an exploded perspective view of the product of the present invention.

FIG. 2 shows the product shown in FIG. 1 in assembled form.

FIG. 3(a)-3(h) are schematic perspective views of each step of the process for making the product comprising a part of the present invention.

FIG. 4 is a block diagram illustrating the steps of the process of the present invention for making the covered face and edge lumber product comprising a part of the present invention.

FIG. 5(a)-5(c) are schematic end elevational views of the product of the present invention showing finished edge bands on both edges and alternative embodiments with a thicker edge band on one side which may be shaped or tapered.

### DETAILED DESCRIPTION OF THE PREFERRED EMBODIMENT

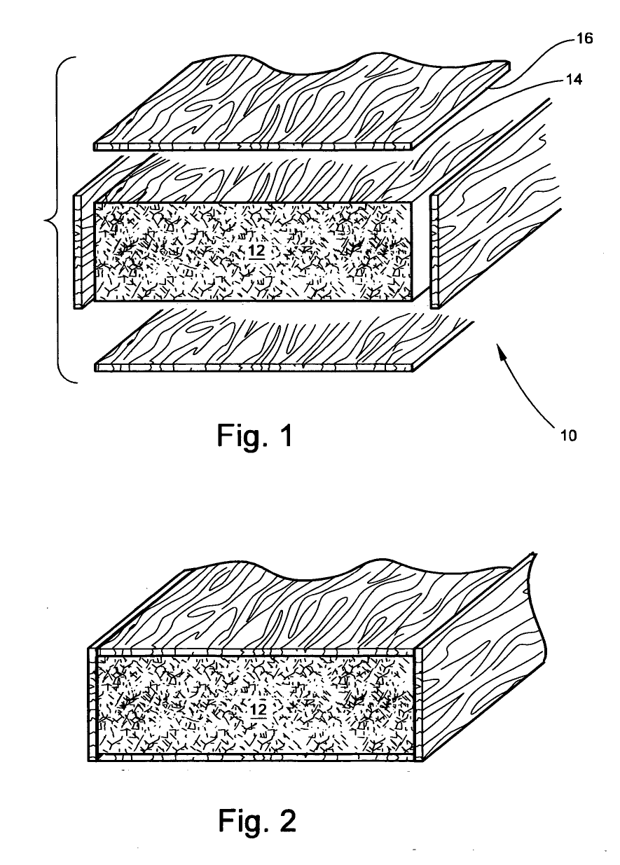

The construction of the present lumber product can be readily understood by reference to FIGS. 1 and 2. The ultimate product 10 is comprised of a core member 12 having bonded to each face 14 a sheet of veneer 16 having a width equal to the width of core member 12.

As an example, FIG. 1 shows a core member 12 and first and second covering veneer sheets 16. The objective is to provide a finished covering wood surface that is substantially identical to, if not better in appearance than, a solid quality hardwood surface of the same material. The desired result is to provide a finished surface of core covering veneer strips that conveys the texture and appearance of a solid wood product.

In producing the end product as described, a large sheet of core material is selected preferably from a number of relatively inexpensive wood products such as, but not limited to, plywood, lumbercore plywood, blackboard, particle board or fiberboard. It is possible to use other than wood core material such as, but not limited to, foam or plastic if desired or convenient so long as the material is stable and not subject to warp or twist.

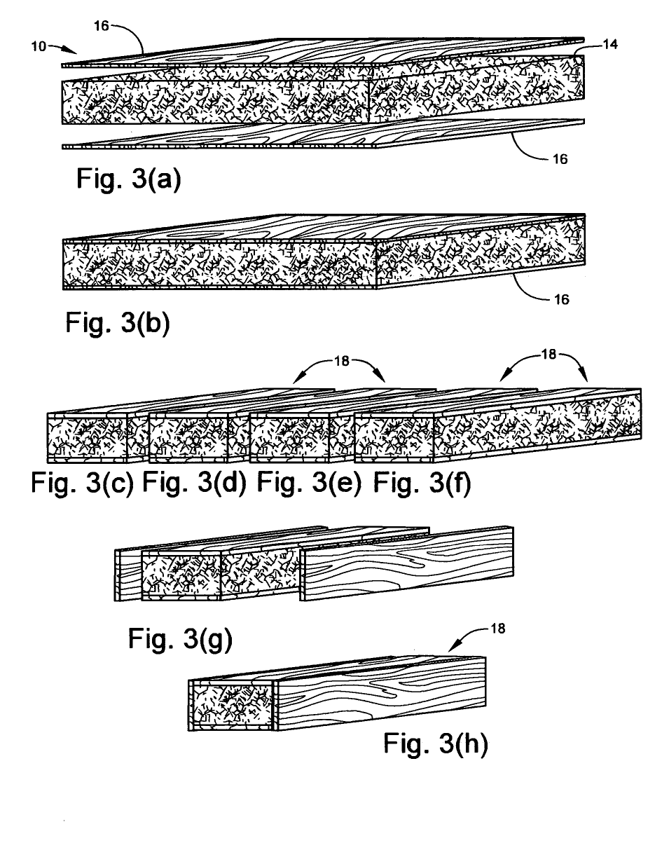

A large sheet of appearance-grade wood veneer is laminated or otherwise bonded to the exposed face or to the face and back of the core member if both will be exposed in the finished product. See FIGS. 3(a) and 3(b). The grade of the veneer used is hereinafter referred to as the “Perceived Grade”.

After veneer sheet or sheets and core member sheet have been bonded, the laminated sheet of materials is then ripped into strips 18. See FIGS. 3(c)-(f). The strips are then edge-covered with edge-covering material such as wood tape, recomposed wood veneer or similar products or small strips of lumber of the same or visually similar species as the Perceived Species. See FIGS. 3(g)-(h). Edge-covering can be done by using a conventional edge-banding machine, a hand-operated edge-banding machine or a hand-applied adhesive-backed edge-banding material.

The assembled product, shown in exploded form in FIG. 1, is seen in FIG. 2. There it is clear that the only way that this product can be distinguished from solid sawn lumber is by the indistinct lines created by the face veneers along the edges of the product. Since such veneer sheets are very thin, the lines they create have minimum visibility.

Core member 12 may be formed from inexpensive common lumber having a variety of knots and other defects. It can also be made up of short end-to-end units of wood which are essentially independent from each other to minimize the tendency of the product to deform due to warpage. If a solid piece of lumber is used for the core member, it can be kerfed in a number of ways to reduce the tendency to develop crook, or bow, or both. Twist can also be virtually eliminated. It is also possible to use synthetic material for core member 12 such as, but not limited to, foams and plastics.

While lumber product 10 is ideally suited for door stiles and rails, it is not restricted to that field. It may be used in most applications where clear lumber is required including any location where the interior construction would not be objectionably exposed if the product was ripped lengthwise.

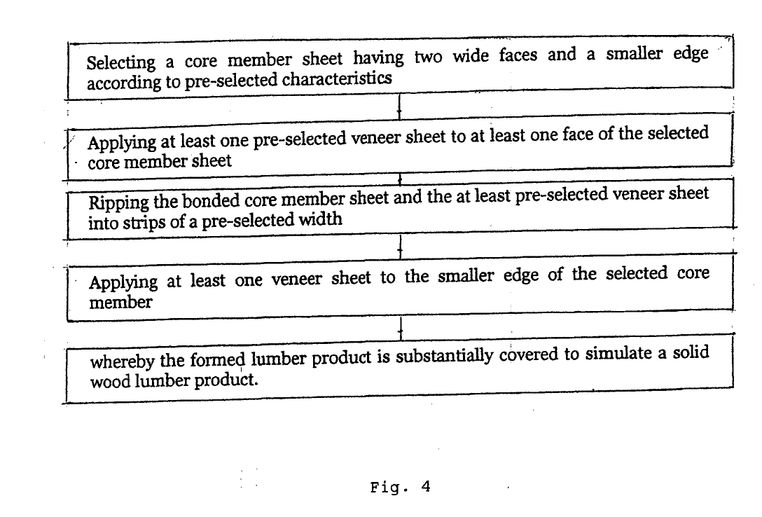

The process for making lumber product 10 is diagramed in FIG. 4. It includes selecting a core member sheet having two wide faces and a smaller edge, according to pre-selected characteristics; applying at least one preselected characteristic to at least one face of the selected core member sheet; ripping the bonded core member sheet and the at least one pre-selected veneer sheet. It next includes ripping the bonded core member sheet and the at least one pre-selected veneer sheet into strips of a pre-selected width. A veneer sheet is then applied to the edge between the two faces. The outer exposed veneer sheet or sheets are then finished. The process is clearly described as making pre-sized, lumber products both in width and length of a desired thickness perceived to be a finished solid wood product.

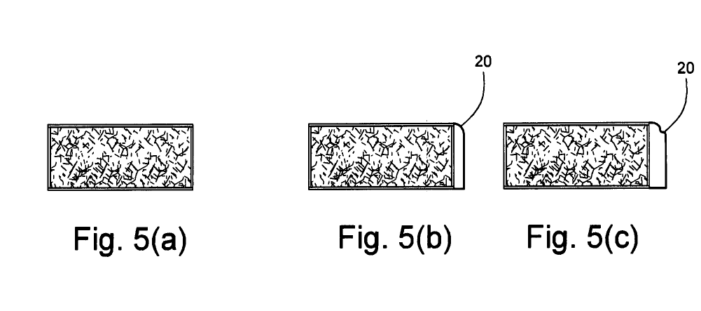

While the formed strips usually have edge bands of the same size as shown in FIG. 5(a), sometimes special needs require one edge band 20 to be thicker than the other and that thicker edge band to be shaped or configured in a special way. See FIGS. 5(b)-(c).

In the preceding description, it can be seen that a covered and edged lumber product and a process for making the product has been provided that will meet all of the advantages of prior art devices and offer additional advantages not heretofore achievable. With respect to the foregoing invention, the optimum dimensional relationship to the parts of the invention including variations in size, materials, shape, form, function, and manner of operation, use and assembly are deemed readily apparent to those skilled in the art, and all equivalent relationships illustrated in the drawings and described in the specification are intended to be encompassed herein.

The foregoing is considered as illustrative only of the principles of the invention. Numerous modifications and changes will readily occur to those skilled in the art, and it is not desired to limit the invention to the exact construction and operation shown and described. All suitable modifications and equivalents that fall within the scope of the appended claims are deemed within the present inventive concept.

What is claimed is:

1. A covered face and edge lumber product comprising: a core member having two wide faces and a smaller edge between the wide faces; at least one veneer sheet overlying and bonded to a wide face of the core member; and at least one veneer sheet overlying and bonded to each narrow edge of the core member so that the lumber product is substantially covered with veneer to simulate a solid wood lumber product.

2. The lumber product as claimed in claim 1 wherein the core member is a non-wood material.

3. The lumber product as claimed in claim 1 wherein the core material is lumbercore plywood.

4. The lumber product as claimed in claim 1 wherein the core material is plywood.

5. The lumber product as claimed in claim 1 wherein the core member includes wood and non-wood materials.

6. A covered and edged lumber product comprising: a core member having two wide faces and a narrow edge between the wide faces; veneer sheets overlying and bonded to each wide face of the core member; and thin sliced finished veneer sheets overlying and bonded to each of the narrow edges of the core member so that the lumber product is substantially covered with finished veneer to simulate a solid wood lumber product.

7. The lumber product as claimed in claim 6 wherein the core material is a non-wood material.

8. The lumber product as claimed in claim 6 wherein the core material is lumbercore.

9. The lumber product as claimed in claim 6 wherein the core material is plywood.

10. The lumber product as claimed in claim 6 wherein the core material includes wood and non-wood materials.

11. A process for forming a lumber product comprising the steps of: selecting a core member sheet having two wide faces and a smaller edge according to pre-selected desirable characteristics; applying at least one pre-selected veneer sheet to at least one face of the selected core member sheet; ripping the core member sheet and the at least one pre-selected veneer sheet into strips of a pre-selected width; and applying at least one veneer sheet to the smaller edge of the selected core member whereby the formed lumber product is substantially covered to simulate a solid wood lumber product.

12. The process as claimed in claim 11 further comprising the steps of: applying a pre-selected veneer sheet to each face of the selected core member.

13. The process as claimed in claim 11 wherein the at least one veneer sheet on each face of the selected core member is unfinished; and the veneer sheet on the edge of the selected core member is unfinished.

14. The process as claimed in claim 12 wherein the outer veneer sheet on each face of the selected core member is a finished sheet of veneer; and the outer veneer sheet on the edge of the selected core member is a finished sheet of veneer.

15. The process as claimed in claim 11 including the step of: forming the at least one veneer sheet applied to each face of the selected core member into strips of a predetermined length before applying the at least one veneer sheet to the edge of the selected core member.

16. The process as claimed in claim 12 including the step of: forming the at least one veneer sheet applied to each face of the selected core member into strips of a predetermined length before applying the at least one additional veneer sheet to each edge of the selected core member.

17. The process as claimed in claim 15 wherein the strips of a predetermined length are formed of a predetermined width.

18. The process as claimed in claim 16 wherein the strips of a predetermined length are formed of a predetermined width.

19. The lumber product as claimed in claim 1 wherein the core member includes non-wood materials.

20. The lumber product as claimed in claim 1 wherein the core member is of a pre-selected length.

21. The lumber product as claimed in claim 6 wherein the core member is of a pre-selected length.
